(19) United States
(12) Patent Application Publication
(10) Pub. No.: US 2015/0109106 A1
(43) Pub. Date: Apr. 23, 2015

(54) System for Holding an RFID within a Slotted Wearable Device

(71) Applicant: VenGo, LLC, Corpus Christi, TX (US)

(72) Inventors: Ruby Gomez, Corpus Christi, TX (US); Joseph Venusto, Concord, NC (US); Raquel Gomez, Concord, NC (US)

(73) Assignee: VENGO, LLC, Corpus Christi, TX (US)

(21) Appl. No.: 14/058,243

(22) Filed: Oct. 20, 2013

(51) Int. Cl. G06K 7/10

(52) U.S. Cl. CPC G06K 7/10
USPC 340/10.1

(57) ABSTRACT

A system for holding an RFID within a slotted wearable device is herein disclosed. The slotted wearable device comprising one or more containers wherein each of the containers comprises a slot, and one or more trays. Moreover, each of the trays is insertable within the slot. Further, each of the trays is capable of housing an RFID chip. In one embodiment, the slotted wearable device further comprises a bracelet body. As such, the container is slidable to the bracelet body. In another embodiment, the containers are each a charm on the bracelet body.

### BACKGROUND

This disclosure relates to a system for holding an RFID within a slotted wearable device.

During recent years RFID technology is gaining more attention as RFID's potential are being discovered. Some of the most popular applications and usage of RFID system involves tracking of products in a supply chain, identification or user profiling, contactless payment, and access tag for different vicinities such as amusement parks, water parks, and other business institutions. However, an RFID system that involves contactless payment usually requires usage of payment cards like credit cards, debit cards, and smart cards. Furthermore, having to pull out payment cards from a bag, or doing the usual transactions with payment cards usually takes time and effort. Moreover, other payment cards use magnetic strip cards that are exposed to being demagnetized or wear away through frequent use. Additionally, payment cards can be more susceptible from being stolen, duplicated, or can be used for fraud. This is because no additional authentication is required when making purchases through credit cards. Since credit card transactions only require a user to swipe and sign any purchases made, it can be an easy target for credit card fraud or identity theft. Thus, an RFID system and wearable RFID device can be useful to address these problems because it keeps the payment device close to the user.

Presently, bracelet systems are available that house an RFID card, but such systems do not allow for multiple RFIDs or for interchangeable RFIDs. As such, to have multiple RFIDs, it is necessary to have multiple bracelets. Additionally, present payment systems are not configured to handle multiple RFIDs.

As such it would be useful to have a system for holding an RFID within a slotted wearable device.

### SUMMARY

A system for holding an RFID within a slotted wearable device is herein disclosed. The slotted wearable device comprising one or more containers wherein each of the containers comprises a slot, and one or more trays. Moreover, each of the trays is insertable within the slot. Further, each of the trays is capable of housing an RFID chip. In one embodiment, the slotted wearable device further comprises a bracelet body. As such, the container is slidable to the bracelet body. In another embodiment, the containers are each a charm on the bracelet body.

### BRIEF DESCRIPTION OF THE DRAWINGS

FIG. 1 illustrates an ornament comprising a tray that mounts (Radio-frequency identification) RFID.

FIG. 2 illustrates another embodiment of an ornament wherein a container can be embedded within a body.

FIG. 3 illustrates another embodiment of an ornament wherein at least two or more RFID can be embedded within a body.

FIG. 4 illustrates another embodiment of an ornament as a chain bracelet.

FIG. 5 illustrates a cutter device.

FIG. 6 illustrates a card placed in between a cutter device.

FIG. 7 illustrates a communication network system of a multiple RFID reader system.

FIG. 8 illustrates an embodiment of a multiple RFID reader.

FIG. 9 illustrates a schematic diagram of a computer.

FIG. 10 illustrates a device data store.

FIG. 11 illustrates a screen displaying card identifiers.

FIG. 12 illustrates an authentication screen.

FIG. 13 illustrates an exemplary method for scanning RFIDs.

### DETAILED DESCRIPTION

Described herein is a system for holding an RFID within a slotted wearable device. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

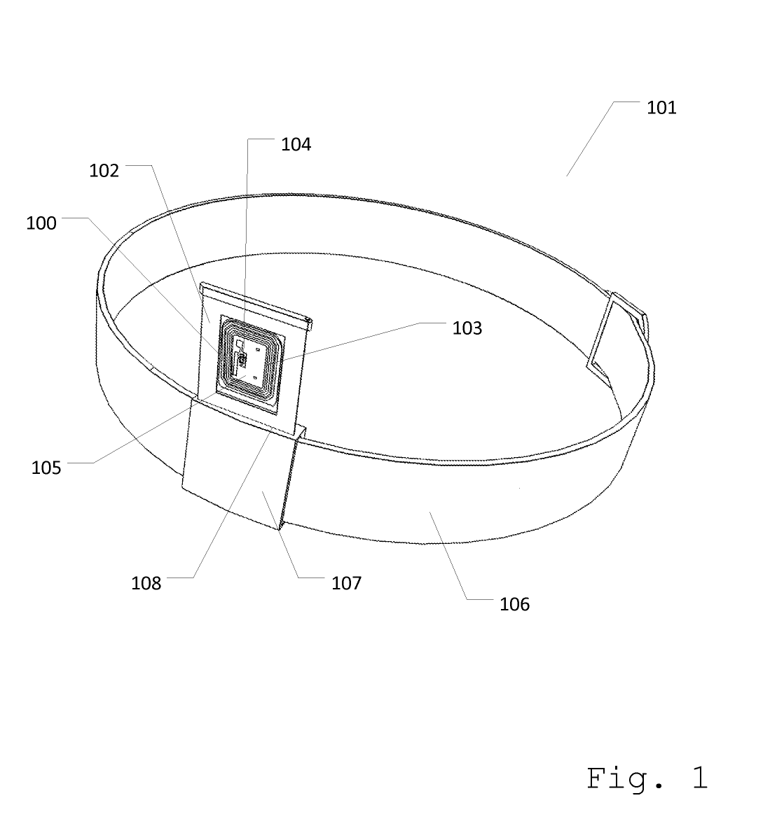

FIG. 1 illustrates a wearable device 101 comprising a tray 102 that mounts (Radio-frequency identification) RFID 100. Wearable device 101 can be any piece of object or accessories that can be worn and used as personal adornment. Wearable device 101 can include but are not limited to necklace, rings, watch, and bracelets that can be used to hold RFID 100. RFID 100 can be attached to accessories and ornaments in such methods discussed herein. As examples, RFID 100 can be attached to a buckle of a belt, can be embedded into a pendant, or mounted into a ring that can resemble a university ring. These embodiments, can allow RFID 100 to be wearable and can allow RFID 100 be easily put on and take off. RFID 100 can be a small electronic device that stores electronic information. RFID 100 can transfer electronic data through radio-frequency electromagnetic fields. RFID 100 can comprise an antenna 103, a RFID tag 104, and a base 105. Antenna can broadcast modulated signals to ensure data exchange between RFID 100 and a reader. Antenna 103 can be a communication device that transmits and receives data signals. As such, RFID tag 104 can be a transponder. Transponder can be a radar transmitter-receiver device that can automatically transmit data signals when triggered with a designated signal. RFID tag 104 can contain payment card information such as card number, card type, and other card identifier, in one embodiment. Base 105 can be any material that holds antenna 103 and RFID tag 104 together. Base 105 can be used to be able to physically attach RFID 100 to any desired object.

Wearable device 101 can comprise a body 106, and one or more container 107. In this embodiment wherein wearable device 101 can be in a form of a bracelet, body 106 can be the predominant portion of wearable device 101 that wraps around the wrist of a user. Body 106 can be made of any material, which can include but are not limited to metal, plastics, rubber, silicon, leather, and/or fabrics. Body 106 can be a flat flexible material that can allow container 107 to be mounted onto body 106. Thus, container 107 can be slid onto body 106. As such, container 107 can be detachable and re-attachable from body 106. In such embodiment, body 106 and container 107 can be interchangeable, allowing a user to combine different designs to personalize wearable device 101. Container 107 can comprise a slot 108. Slot 108 can be a long and narrow slit within container 107 that is capable of receiving tray 102. Tray 102 can be a flat container comprising a shallow portion capable of mounting RFID 100. In such embodiment, tray 102 can be ejectable from slot 108. In another embodiment, container 107 and body 106 can be a single device. As such, container 107 can be permanently fixed and embedded within body 106.

In another embodiment, RFID 100 can be mounted within container 107 that can allow an RFID scanner to read and gather information from RFID 100. In such embodiment, body 101 can be utilized as RFID's 100 protection from exposure to harsh conditions such as hard impacts, extreme temperatures, and moisture exposure.

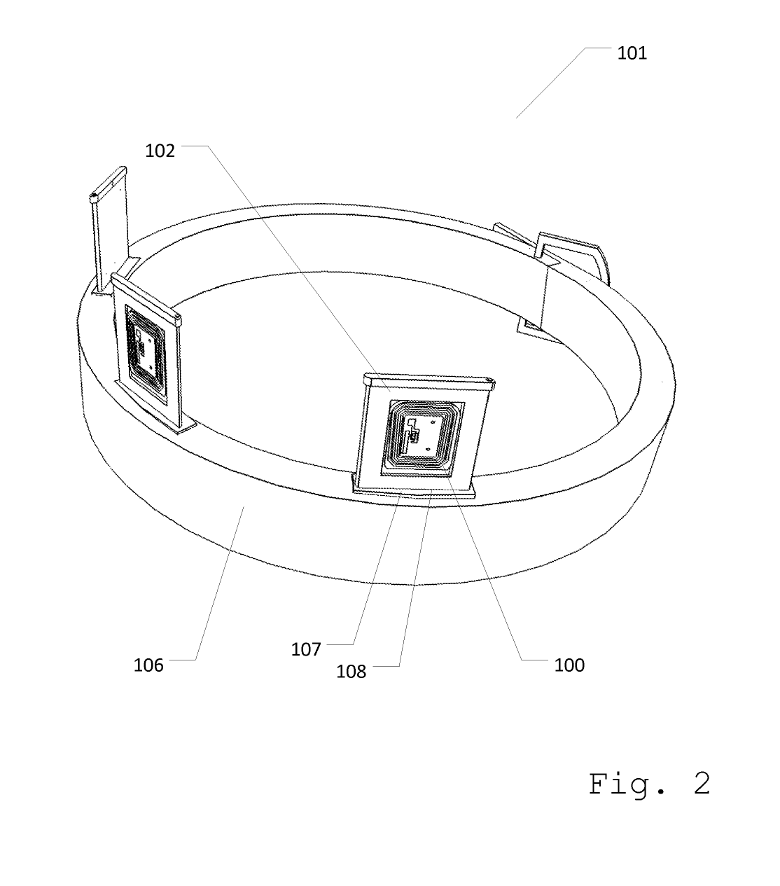

FIG. 2 illustrates another embodiment of wearable device 101 wherein container 107 can be embedded within body 106. As such, container 107 can be permanently attached within body 106 of wearable device 101. In this embodiment, body 106 can mount at least two or more RFID 100. In one embodiment, container 107 can be attachable within body 106 through soldering, welding, or through the use of any adhesive materials. In another embodiment, body 106 and container 107 can be a single device. In such embodiments, body 106 can comprise two or more slots 108, each capable of housing trays 102. Thus, RFID 100 mounted on each tray 102 can be removable from body 106.

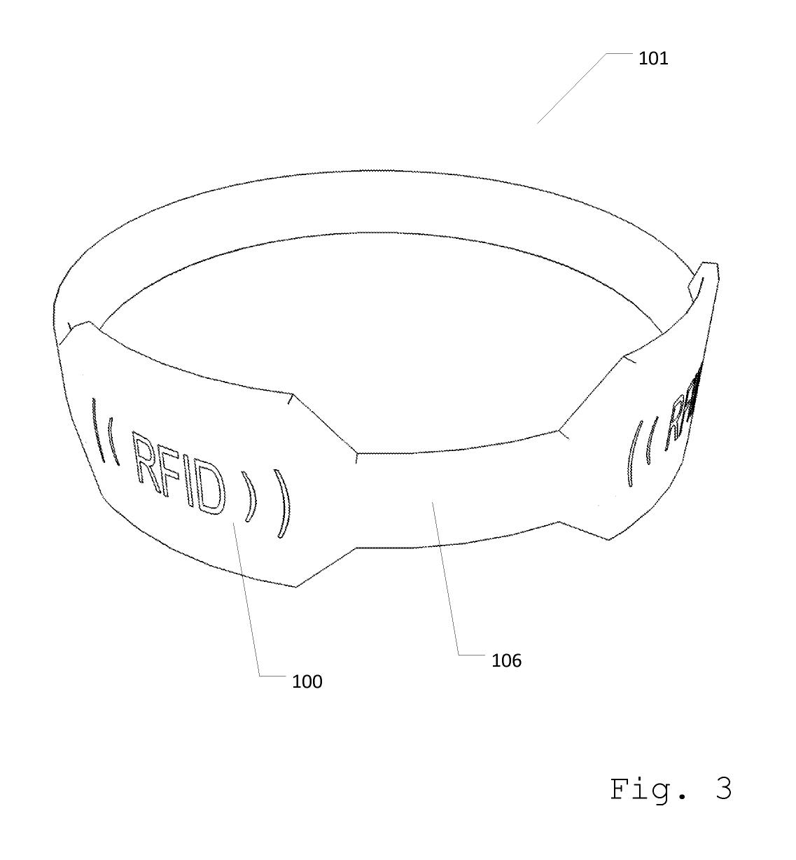

FIG. 3 illustrates another embodiment of wearable device 101, wherein a plurality of RFIDs 100 can be embedded within body 106. In this embodiment, body 106 can be made from water resistant materials that include, but are not limited to, silicone, plastics, and/or rubber material. This can ensure that RFID 100 can be securely and permanently attached within body 106. Moreover, RFID 100 can be protected from corrosion or scratches. Furthermore, body 106 in this embodiment can be utilized as RFID's 100 protection from exposure to harsh conditions such as hard impacts, extreme temperatures, and moisture exposure. Since, RFID 100 in this embodiment can be built into wearable device 101; RFID 100 cannot be interchanged or replaced with another RFID 100.

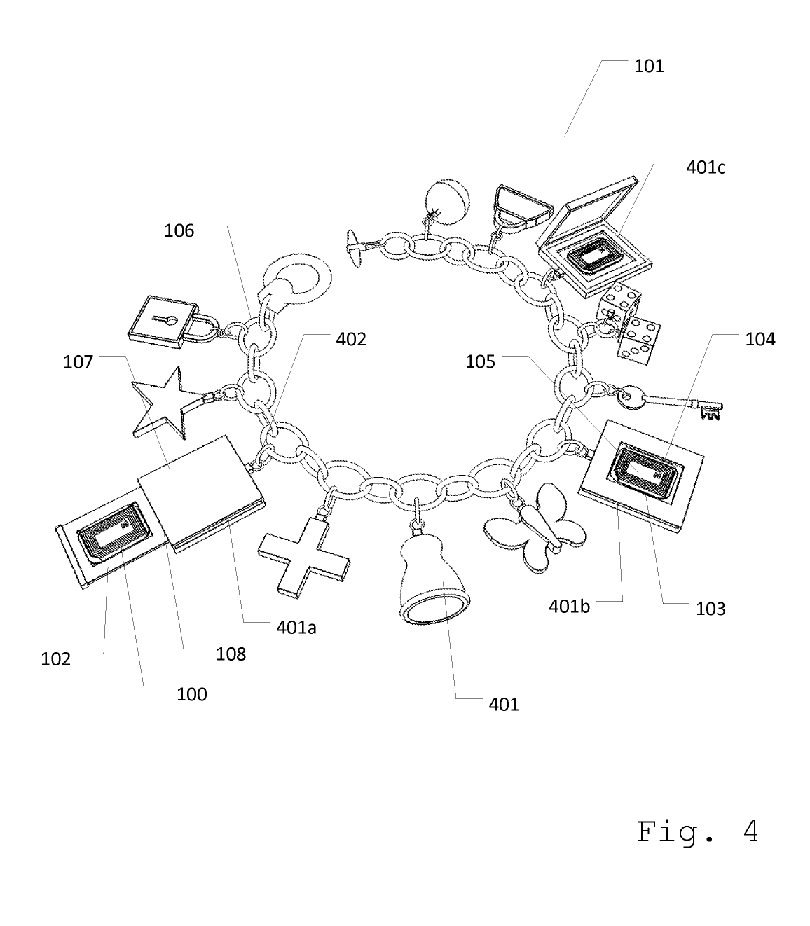

FIG. 4 illustrates another embodiment of wearable device 101 as a chain bracelet. In this embodiment, body 106 can be made of chains carrying one or more charms 401. Charm 401 can be any small wearable device attached by a loop 402 on body 106. Loop 402 can be any type of fastener that can attach charm 401 to body 106, such as a jump ring or a clasp. Moreover, charm 401 can be detached from body 106 through loop 402. In one embodiment, charm 401 and base 105 can be a single device hanging from wearable device 101. In such embodiment, antenna 103 and RFID tag 104 can be attached or embedded onto charm 401b. In another embodiment, charm 401a can be container 107. As such, RFID 100 can be mounted on tray 102 and insertable within container 107. In such embodiment, RFID 100 can be removable from slot 108. Further in another embodiment, charm 401c can be in a form of locket. As such, the space within charm 401 can be used to store RFID 100.

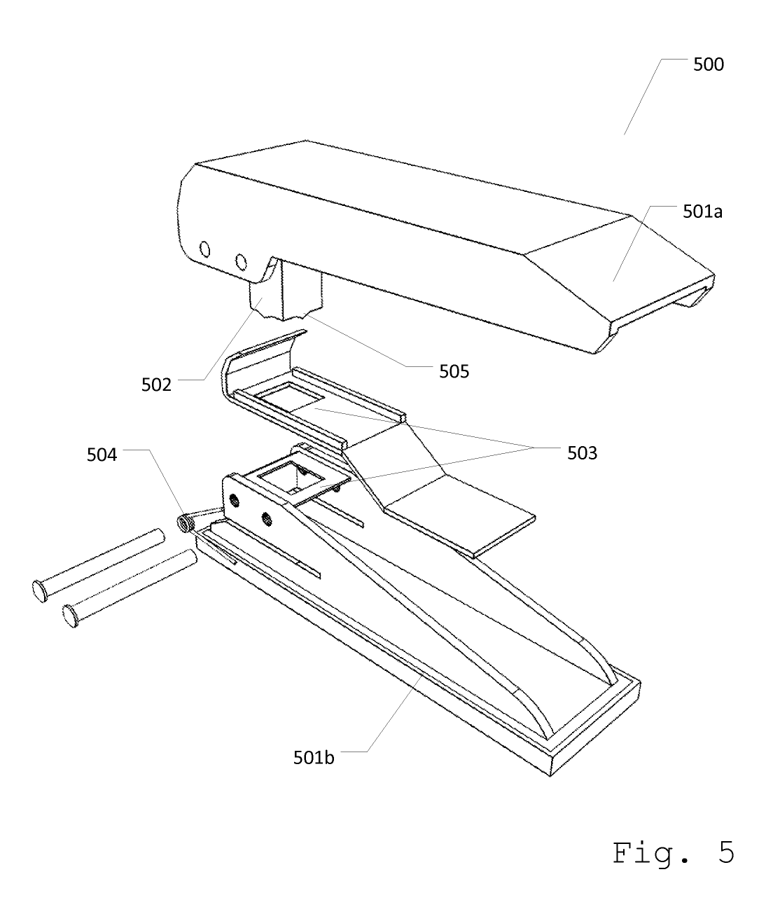

FIG. 5 illustrates a cutter device 500 comprising a pair of lever arms 501, a vertical guide 502, one or more horizontal guides 503, and a biasing device 504. Lever arm 501 can be a long durable material, which can be used to cut vertical guide 502 through a credit card. Lever arms 501 can be used to press against each other creating pressure between vertical guide and card. Lever arms 501 can comprise a first lever arm 501a and a second lever arm 501b. In one embodiment, second lever arm 501b can be immoveable. In such embodiment, the first lever arm 501a can be pressed towards second lever arm 501b. In another embodiment, lever arms 501 can each be a handle that enables a user to manipulate movements of both lever arms 501. In such embodiment, first lever arm 501a and second lever arm 501b can be movable. In this embodiment, lever arms 501 can have a scissor-like handle. Vertical guide 502 can be mounted in between lever arms 501. Furthermore, vertical guide 502 can be a vertical shaft whose inner end portion can be attached to first lever arm 501a. The outer end portion of vertical guide 502 can comprises a blade 505. Blade 505 can be a sharp rectangular edge of vertical guide 502 configured in a shape of RFID 100. Horizontal guides 503 can comprise a top guide 503a and a bottom guide 503b. Each of horizontal guides 503 can be flat material comprising an orifice 506 insertable by vertical guide 502. Horizontal guides 503 can ensure the proper alignment of vertical guide 502 with lever arm 501. Horizontal guides 503 can aid in ensuring that a credit card placed in between lever arm 501 stays in place. Horizontal guide can be substantially the same width as the height or width of a credit card. Orifice 506 of bottom guide 503b can have a clearance that can be passable by vertical blade 502. As such, as lever arms 501 are pressed together, blade 505 can pass through orifices 506. Biasing device 504 such as a spring can be used to provide resistance in between a first lever arm 501a and a second lever arm 501b. Biasing device 504 can be attached in between first lever arms 501a and a second lever arm 501b.

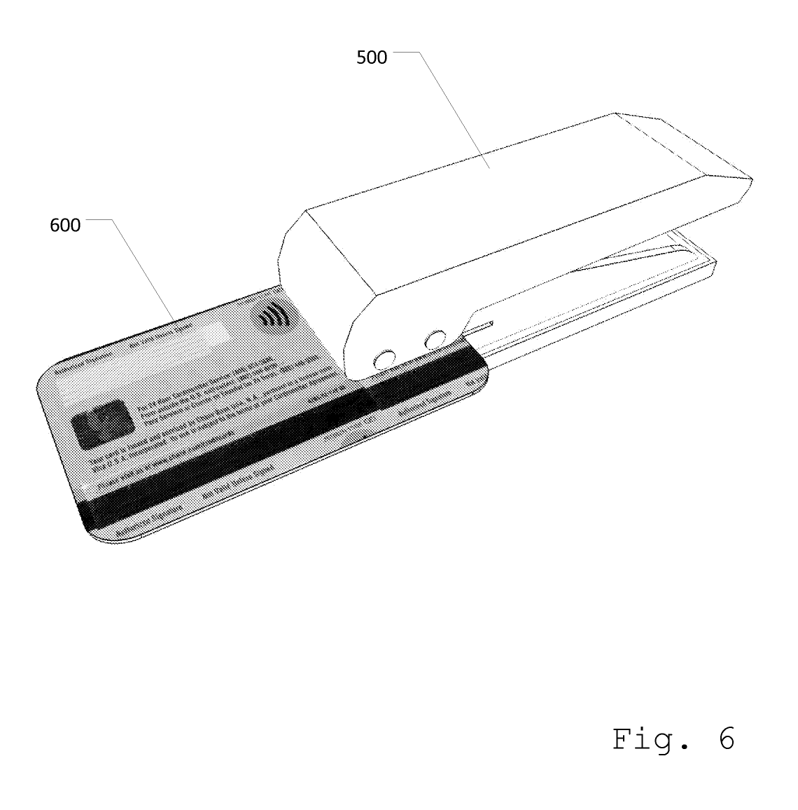

FIG. 6 illustrates a card 600 placed in between cutter device 500. Card 600 can be any plastic material that is issued by a bank or business, which authorizes holder to purchase goods and services such as credit cards, payment system cards, and debit cards. In one embodiment, card 600 can be associated with a profile. Cutter device 500 can be a device used to remove RFID 100 from card 600. Cutter device 500 can be made from durable material such as metal that is configured to punch through card 600. Card 600 can be positioned in between first lever arm 501a and second lever arm 501b wherein orifice 506 of bottom guide 503b can be aligned around RFID 100 of card 600. Once card 600 is in the proper position, lever arm 501 can be pressed together which can push blade 505 through card 600. The exerted pressure on lever arms 501 can force blade 505 to pass through card 600 towards the clearance on bottom guide 503. Since blade 505 can be configured in the shape of RFID 100, the cut made on card 600 can be contoured around RFID 100, ensuring that RFID 100 can be intact when detached from card 600.

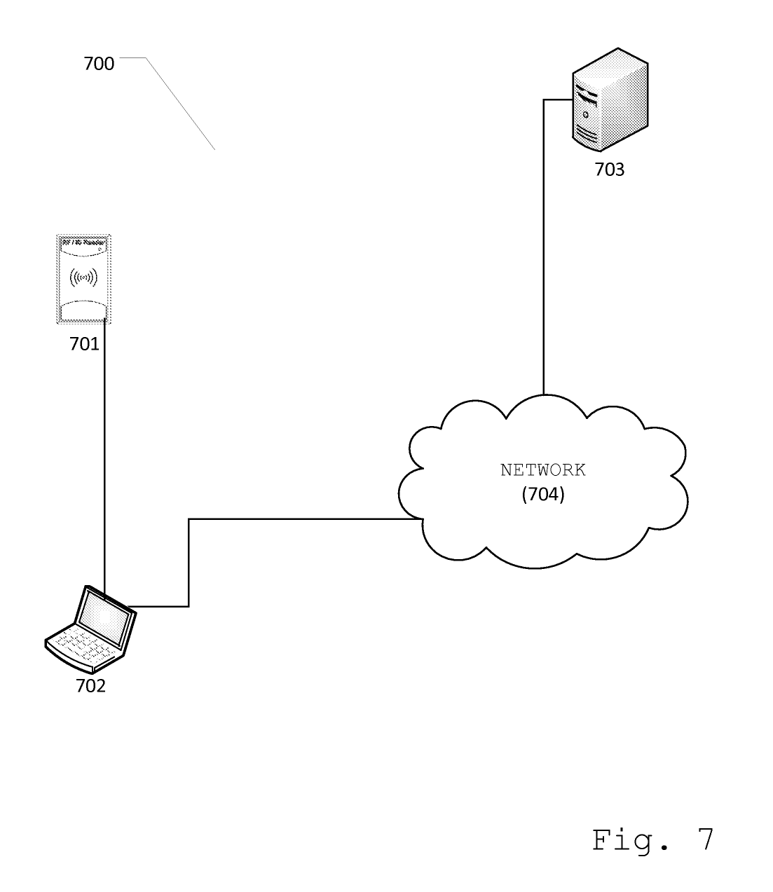

FIG. 7 illustrates a communication network system comprising a multiple RFID reader 701, a computer 702, and one or more servers 703 connected via a network 704. In one embodiment, multiple RFID reader 701 can be connected to computer 702 to be able to transmit and display the tag data on RFID 100. In another embodiment, multiple RFID reader 701 and computer 702 can be a single device capable of transferring and receiving electronic data through network 704. As such, captured data information from RFID 100 can be displayed on an output device of multiple RFID reader 701. In one embodiment, multiple RFID reader 701 can allow an automated scanning of RFID 100 that is within the range of multiple RFID reader 701. In another embodiment, multiple RFID reader 701 can be controlled manually that can require actuation of an input device to initiate multiple RFID reader 701 in scanning RFID 100.

Computer 702 can receive, store and send out data information through network 704. Computer 702 can include, but is not limited to, a laptop, desktop, tablet, or any other computing communication device capable of transmitting card information data across network 704 to server 703.

Server 703 can provide and perform computational tasks across network 704. Server 703 can send and receive data to and from computer 702. Moreover, server 703 can contain data from payment institutions, financial institutions, and bank institutions. Network 704 can be a wide area network (WAN), or a combination of local area network (LAN), and/or piconets. Network 704 can be hard-wired, wireless, or a combination of both. A LAN can be a network within a single business while WAN can be an Internet.

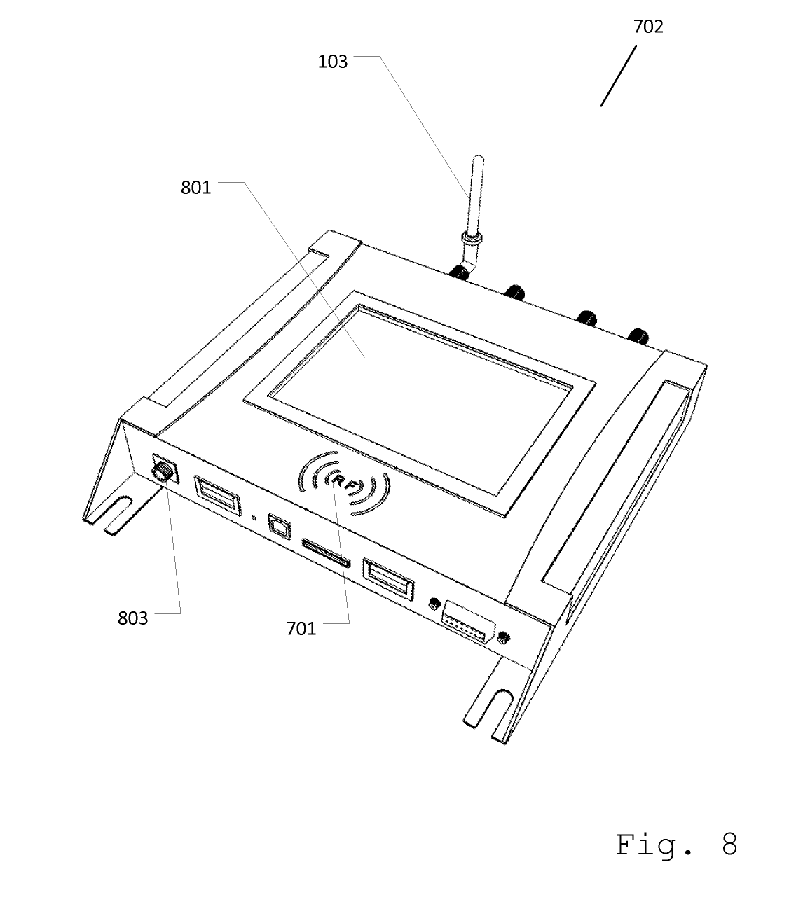

FIG. 8 illustrates an embodiment of multiple RFID reader 701 combined with a computer 702. Computer 702 can comprise a screen 801, RFID reader 701, a power source 803, and a means to connect to network 704. In such embodiment, multiple RFID reader 701 can be a read-zone or a portal deployed to allow reading of RFID 100. Moreover RFID scanner 802 can comprise one or more antennas 103 capable of communicating with multiple RFID tags 104 near simultaneously. Further, power source 803 in this embodiment can include the usage of a power cable and a power outlet. In another embodiment, multiple RFID reader 701 can be separated but electrically connected to computer 702.

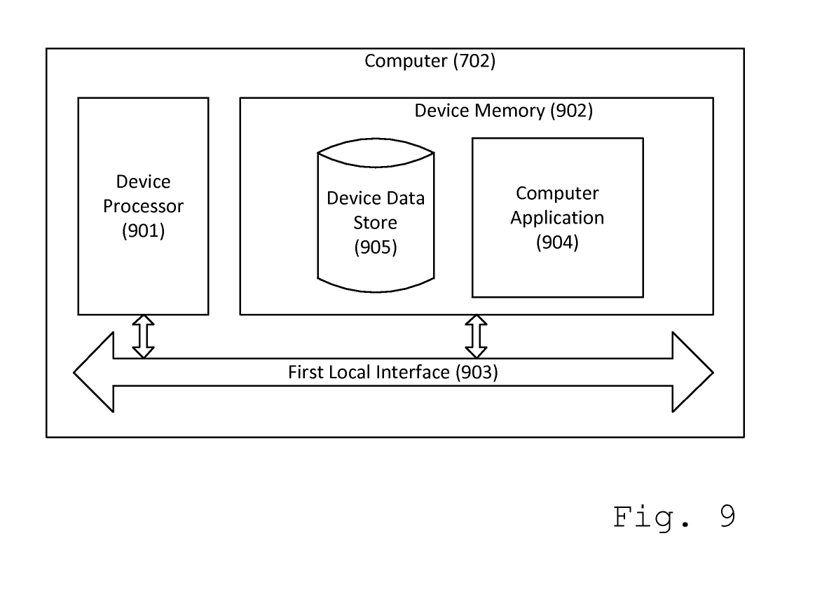

FIG. 9 illustrates a schematic diagram of computer 702 according to an embodiment of the present disclosure. Computer 702 can comprise a device processor 901, and a first local interface 903. First local interface 903 can be a program that controls a display for the user, which can allow user to view and/or interact with server 703. Computer 702 can be a processing unit that performs a set of instructions stored within device memory 902. Device memory 902 can comprise a computer application 904, and a device data store 905. Computer application 904 can be a program providing logic for computer 702. Device data store 905 can be collections of data accessible through computer application 904. Further, computer application 904 can perform functions such as adding, transferring, and retrieving information on device data store 905 using first local interface 903. In one embodiment, computer 702 and server 703 can be the same device or set of devices.

Further, an input data 906 or data signals captured from RFID 100 can be received and analyzed by device processor 901. Processor 901 can be a device that executes programs stored in device memory 902. Memory 902 can be a physical device used to store programs and/or data. Computer 702 can further comprise a communication hardware 907 can be any hardware to support communication protocols known in the art, such as hardware for packetizing data, antennas, and hardwire communication ports. Processes can include storing input data 906 to device memory 902, verifying input data 906 is valid and conforms to preset standards, or ensuring all required data. Input data 906 can be sent to communication hardware 907 for communication over network 704.

Computer 702 includes at least one processor circuit, for example, having device processor 901 and device memory 902, both of which are coupled to first local interface 903. To this end, computer 702 can comprise, for example, at least one server, computer or like device. First local interface 903 can comprise, for example, a data bus with an accompanying address/control bus or other bus structure as can be appreciated.

Both data and several components that are executable by device processor 901 are stored in device memory 902. In particular, computer application 904 and, potentially, other applications are stored in the device memory 902 and executable by device processor 901. Also, device data store 905 and other data can be stored in device memory 902. In addition, an operating system can be stored in device memory 902 and executable by device processor 901.

Other applications can be stored in device memory 902 and executable by device processor 901. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in device memory 902 and can be executable by device processor 901. In this respect, the term “executable” can mean a program file that is in a form that can ultimately be run by device processor 901. Examples of executable programs can include a compiled program that can be translated into machine code in a format that can be loaded into a random access portion of device memory 902 and run by device processor 901, source code that can be expressed in proper format such as object code that is capable of being loaded into a random access portion of device memory 902 and executed by device processor 901, or source code that can be interpreted by another executable program to generate instructions in a random access portion of device memory 902 to be executed by device processor 901, etc. An executable program can be stored in any portion or component of device memory 902 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

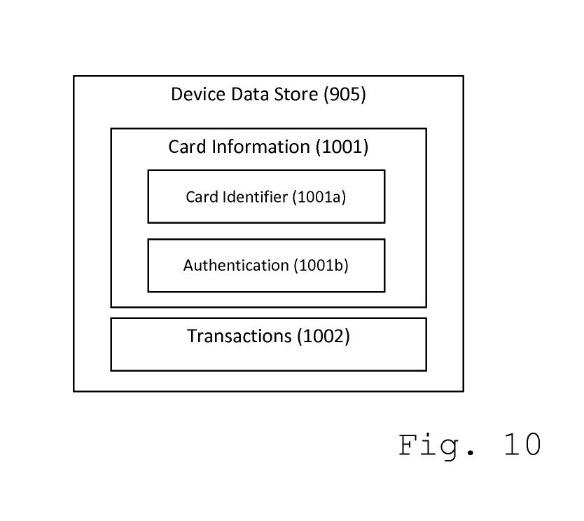

FIG. 10 illustrates device data store 905 comprising temporary card information 1001, and transaction records 1002. Card information 1001 can be unique account information pulled down from a bank or credit card company server. Information can include a cardholder's name, card type, bank, bank branch, and expiration date. In one embodiment, card identifier 1001a can be a card number. Further, each RFID tag 104 can comprise electronic data or an identifier matching card identifier 1001a. As such, RFID tag 104 and card identifier 1001a can be compared. Authentication 1001b can be a security measure to ensure that the user is an authorized user of card information 1001. Transaction 1002 can comprise activities completed by computer 702 over a time period.

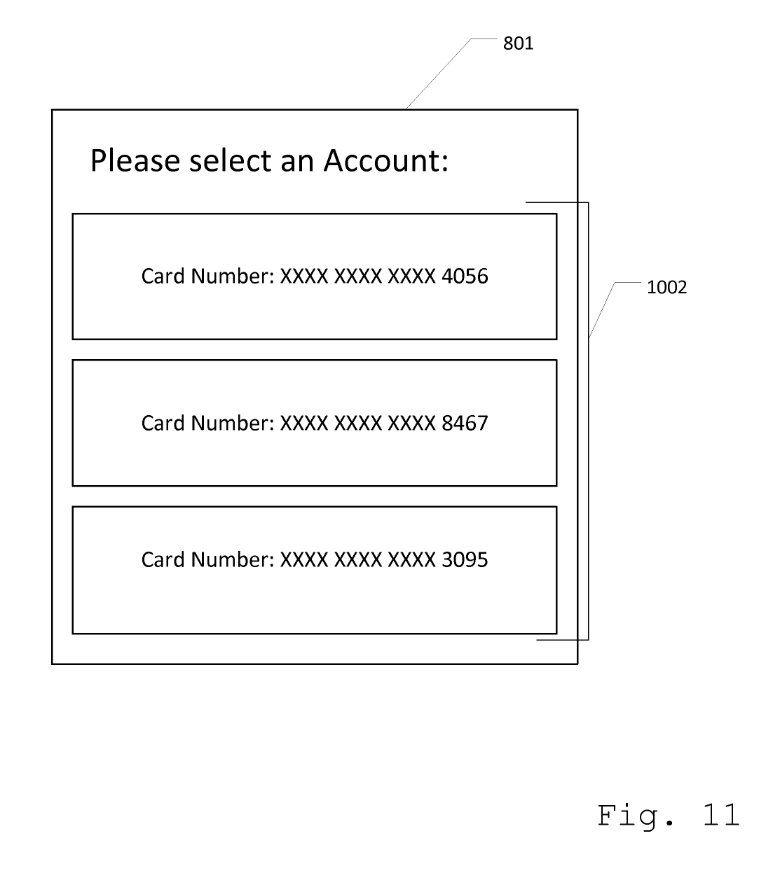

FIG. 11 illustrates screen 801 displaying card identifiers 1002 scanned through multiple RFID reader 701. In one embodiment, a user can allow wearable device 101 be read by multiple RFID reader 701, manually. In such embodiment, the user can interact with multiple RFID reader 701 such as pressing a button, to trigger scanner 802 to be activated. In another embodiment, placing wearable device 101 within a readable range can automatically trigger multiple RFID reader 701. As such, multiple RFID reader 701 can read RFIDs 100 mounted on wearable device 101. In such scenario, each RFID tag 104 or card information 1001 found on each RFID 100 can be stored within device data store 905. As such, a portion of each card information 1001 such as card identifier 1001a can be displayed on screen 801. A user can then be prompted to select at least one from the list of card identifier 1001a.

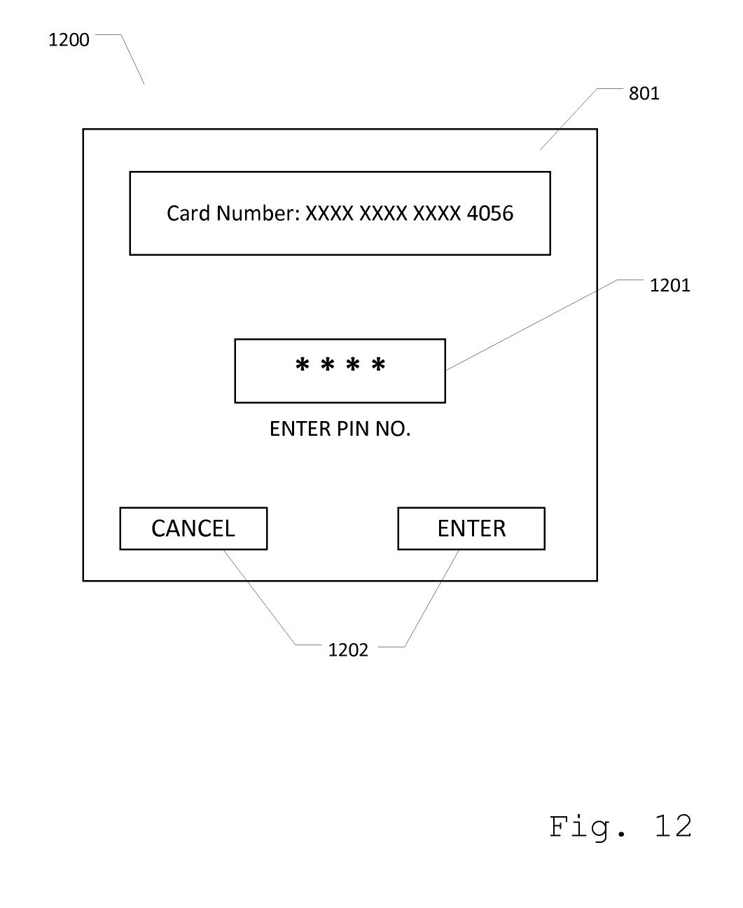

FIG. 12 illustrates an authentication screen 1200. After card identifier 1001a is selected, authentication screen 1200 can be displayed. Authentication screen 1200 can comprise an input box 1201 and one or more system buttons 1202. Input box 1201 can be a text field allowing the user to enter a password or a pin before proceeding with any transactions. System buttons 1202 can allow the user to proceed or cancel the transaction. In one embodiment, entering an incorrect pin or password several times can trigger device processor 901 to send an alert to server 703. This in turn, can block the selected card information 1001 temporarily. This can ensure that only authorized user can perform the transactions for each card information 1001. Once card identifier 1001a is authenticated, card identifier 1001a can be communicated to server 703 through network 704. Thus, server 703 can communicate to computer 702 the authorized transaction 1002 for the card identifier 1001a selected. Further, each card information 1001 can be displayed as a button, or next to a check box, or radio buttons. This can allow the user to only select one card identifier 1001a from screen 801 for each transaction. In one embodiment, a user can choose multiple cards and split a transaction.

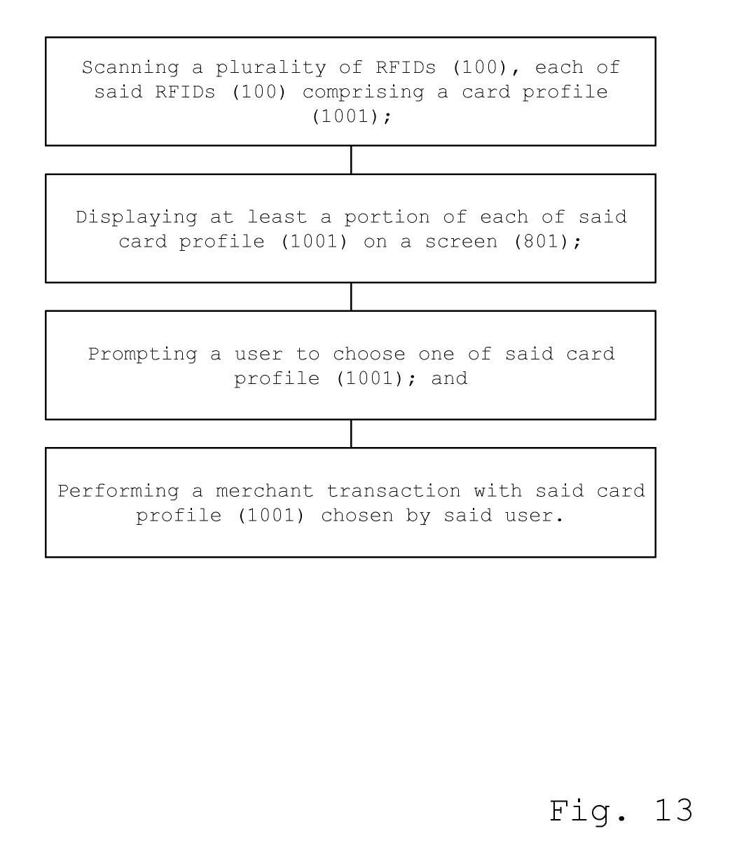

FIG. 13 illustrates an exemplary method for scanning RFIDs 100. Electronic data on RFID tag 104 waits to be read. Antenna 103 of multiple RFID reader 701 can broadcast an electromagnetic energy to communicate with RFID tag 104 for each of said RFID 100. In one embodiment, multiple RFID system 700 can follow the radio regulations of ITU-R (International Telecommunications Union for Radio Communication). Thus, multiple RFID system 700 can use radio waves and frequency ranges that are reserved for RFID technology. As such, multiple RFID reader 701 can be used in scanning a plurality of RFIDs 100. Each of said RFIDs 100 can comprise a card information 1001. After every RFIDs 100 are scanned, each of said card information 1001 can then be stored within a device memory 902. Screen 801 can display at least a portion of each of said card information 1001. As such, a card identifier 1001a can be displayed for each of card information 1001. A user can then be prompted to choose one of said card information 1001 (or card 600) to use for his desired transaction. Once card information 1001 is selected, device processor 901 can communicate with server 703 to authorize any applicable transaction 1002 for the selected card information 1001. In one embodiment, an authentication 1001b in a form of a PIN code, a signature, or a password can be required before any transaction 1002 can proceed. As such, after selecting card identifier 1001a from screen 801, the user may be required to enter authentication 1001b to validate and continue with transaction 1002. When authentication 1001b is correctly supplied, user can perform the usual card transactions 1002 such as checking current balance, deposit funds, transfer funds, or even do funds withdrawals. Once transaction 1002 is completed summary information of transactions 1002 can be displayed on screen 801.

In the various embodiments listed above, parameter can either be user defined, chosen by computer application 904, or can be an inherent programming aspect (such as string matching for a name) of either of the applications mentioned.

Device memory 902 can include both volatile and nonvolatile memory and data storage components. Volatile components do not retain data values upon loss of power. Nonvolatile components, on the other hand, retain data upon a loss of power. Thus, device memory 902 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, device processor 901 can represent multiple device processors 901. Likewise, device memory 902 can represent multiple device application memories 902 that operate in parallel processing circuits, respectively. In such a case, first local interface 903 can be an appropriate network, including network 704 that facilitates communication between any two of the multiple device processors 901, between any device processor 901 and any of the device memory 902, or between any two of the device memory 902, etc. First local interface 903 can comprise additional systems designed to coordinate this communication, including, but not limited to, performing load balancing. Device processor 901 can be of electrical or of some other available construction.

Although computer application 904, and other various systems described herein can be embodied in software or code executed by general purpose hardware discussed above, computer application 904 can also be embodied in dedicated hardware or a combination of software/general purpose hardware and dedicated hardware. If embodied in dedicated hardware, each computer application 904 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 13 shows the functionality and operation of an implementation of portions of computer application 904. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as device processor 901 in a computer system or other system. The machine code can be converted from the source code, etc. If embodied in hardware, each block can represent a circuit or a number of interconnected circuits to implement the specified logical function(s).

Although the flowchart of FIG. 12 show a specific order of execution, the order of execution can differ from what is depicted. For example, the order of execution of two or more blocks can be rearranged relative to the order shown. Also, two or more blocks shown in succession in FIG. 6 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including computer application 904, can be embodied in any computer-readable storage medium for use by or in connection with an instruction execution system such as, device processor 901 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A slotted wearable device comprising
one or more containers, each of said containers comprising a slot; and
one or more trays, each of said trays insertable within said slot, further each of said trays capable of housing an RFID chip.

2. The slotted wearable device of claim 1 further comprising a bracelet body, said container slidable to said bracelet body.

3. The slotted wearable device of claim 2 wherein said container is detachable and re-attachable to said bracelet body.

4. The slotted wearable device of claim 2 wherein said container is permanently fixed within said bracelet body.

5. The slotted wearable device of claim 1 wherein said tray ejectable from said slot.

6. The slotted wearable device of claim 1 wherein said container can comprise a conductive material.

7. The slotted wearable device of claim 1 wherein said container can comprise a water resistant material.

8. The slotted wearable device of claim 2 wherein said bracelet body is a chain.

9. The slotted wearable device of claim 1 wherein said containers are each a charm on said bracelet body.

10. The slotted wearable device of claim 9 wherein said RFID can be embedded to said charm.

11. The slotted wearable device of claim 9 wherein said charm insertable by said tray, further wherein said RFID mountable to said tray.

12. The slotted wearable device of claim 9 wherein said charm is a locket, further wherein said RFID stored within said locket.

13. The slotted wearable device of claim 9 wherein said charm detachable from said bracelet body through said loop.
